(19) United States
(12) Patent Application Publication
(10) Pub. No.: US 2014/0108185 A1
(43) Pub. Date: Apr. 17, 2014

(54) Methods and Apparatus for Knowledge Processing System

(71) Applicants: Dawei Shen, Cambridge, MA (US); Marshall Van Alstyne, Newton, MA (US); Andrew Lippman, Salem, MA (US)

(72) Inventors: Dawei Shen, Cambridge, MA (US); Marshall Van Alstyne, Newton, MA (US); Andrew Lippman, Salem, MA (US)

(73) Assignee: MASSACHUSETTS INSTITUTE OF TECHNOLOGY, Cambridge, MA (US)

(21) Appl. No.: 14/051,450

(22) Filed: Oct. 11, 2013

Related U.S. Application Data
(60) Provisional application No. 61/712,655, filed on Oct. 11, 2012.
(60) Provisional application No. 61/800,524, filed on Mar. 15, 2013.

(51) Int. Cl. G06Q 30/06; G06Q 20/06

(52) U.S. Cl. CPC G06Q 30/0611; G06Q 20/065
USPC 705/26.4

(57) ABSTRACT

In exemplary implementations of this invention, a knowledge processing system performs decentralized knowledge acquisition from human experts. The system may store the acquired knowledge in a knowledge database. The system may include an AI expert system to apply computer reasoning to data stored in the knowledge database. The system may provide humanly perceptible outputs to human experts to increase the likelihood that the human experts will pay attention to requests for information or to other communications, contribute knowledge objects in response to a query, provide “high quality” information, tag knowledge objects in the database, or review knowledge objects.

### RELATED APPLICATIONS

This application is a non-provisional of, and claims the benefit of the filing date of, U.S. Provisional Application No. 61/712,655, filed Oct. 11, 2012, and U.S. Provisional Application No. 61/800,524, filed Mar. 15, 2013. The entire disclosures of both of these provisional patent applications are incorporated herein by reference.

### STATEMENT REGARDING FEDERALLY SPONSORED RESEARCH OR DEVELOPMENT

This invention was made with U.S. government support under Grant Number IOS 0925004 and Grant Number 1217250, each awarded by the National Science Foundation. The government has certain rights in this invention.

### FIELD OF THE TECHNOLOGY

In illustrative implementations, the present invention relates generally to knowledge processing systems, including knowledge acquisition tools and expert systems.

### COMPUTER PROGRAM LISTING

Attached is an ASCII text file 15887T_source.txt, dated Oct. 9, 2013 with a size of about 27 KB (the “Source Code”). This ASCII text file comprises a computer program listing for software in a prototype implementation of this invention. This ASCII text file is incorporated by reference herein.

### SUMMARY

In exemplary implementations of this invention, a knowledge processing system (KPS) performs decentralized knowledge acquisition from human experts. The KPS may store the acquired knowledge in a knowledge database. The KPS may include an AI expert system to perform computer reasoning to analyze or draw inferences from data stored in the knowledge database.

The KPS may perform information retrieval to retrieve data from the knowledge database, in response to information requests from human users.

To facilitate the information retrieval and expert system reasoning, the KPS may index knowledge objects (e.g., documents or other data) in the database and calculate relationships among knowledge objects in the database.

The AI expert system may perform computer reasoning about data in a database. In addition, the AI expert system may have a dialogue interface to communicate with the users (e.g., it may be what is commonly called a “conversational” expert system). For example, the AI expert system may employ the dialogue interface to ask one or more human experts to provide missing data (data not currently in a relevant database) that is needed for the AI expert system to solve a problem.

In exemplary implementations, the KPS may perform decentralized knowledge acquisition from human users. In this decentralized knowledge acquisition, the KPS interacts with human users such that: (1) human users can generate queries (thereby determining the knowledge to be acquired) and (2) human experts (also users of the system) can provide answers to the queries. Typically, the answers comprise knowledge that is missing from the knowledge database. The KPS may add the data in the answers to the knowledge base and index it.

This decentralized knowledge acquisition can respond flexibly to needs of the human users of the KPS—acquiring knowledge that the users actually want, rather than in accordance with some “central master plan” that is imposed top down.

The system may provide humanly perceptible outputs to human experts to increase the likelihood that the human experts will: (a) pay attention to requests for information or to other communications; (b) contribute knowledge objects in response to a query; (c) provide “high quality” information; (d) tag knowledge objects in the database, or (e) review knowledge objects.

This invention has many practical applications. For example, the knowledge processing system may (in illustrative implementations) be used to acquire and share knowledge in the following applications, among others: (a) an online knowledge acquisition tool provided over the Internet, administered by a not-for-profit institution and accessible for free by the public; and (b) a knowledge acquisition tool provided free to students, teachers, and staff at a university.

The description of the present invention in the Summary and Abstract sections hereof is just a summary. It is intended only to give a general introduction to some illustrative implementations of this invention. It does not describe all of the details of this invention. This invention may be implemented in many other ways.

### BRIEF DESCRIPTION OF THE DRAWINGS

FIG. 1 shows an overview of a knowledge processing system.

FIG. 2 shows hardware components of a knowledge processing system.

FIG. 3 shows an overview of a knowledge acquisition engine.

FIG. 4 shows an overview of a reinforcement subengine.

The above Figures show some illustrative implementations of this invention, or provide information that relates to those implementations. However, this invention may be implemented in many other ways. The above Figures do not show all of the details of this invention.

### DETAILED DESCRIPTION

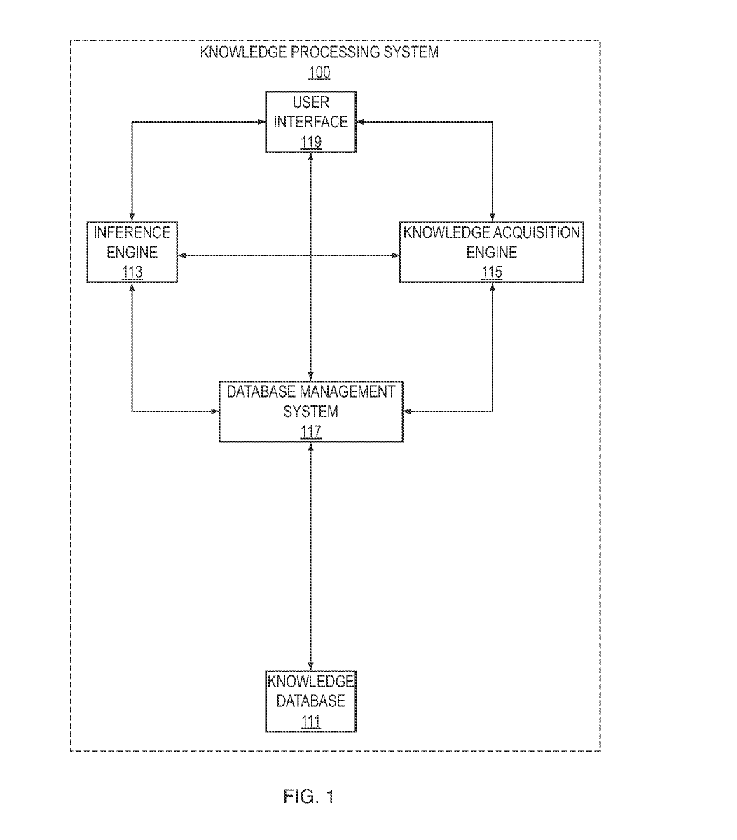

FIG. 1 shows an overview of a knowledge processing system, in an illustrative implementation of this invention. The knowledge processing system (KPS) 100 comprises a database 111, an inference engine 113, a knowledge acquisition engine 115, a database management system (DBMS) 117, and a user interface 119.

The DBMS 117 may define, create, query, update and administer the database 111.

For example, if the database 111 is a document based database: (a) the DBMS 117 may access documents in the database using a key-document approach, in which each document is addressed with a unique key; (b) the keys may be simple strings, URIs, or paths; and (c) the DBMS 117 may employ NoSQL (Not Only SQL).

Or, for example, if the database 111 is a relational database: (a) the DBMS 117 may access and store data in accordance with relations (e.g. base relations, derived relations, tables, base table relations, or relation variables), subject to constraints; and (b) the DBMS 117 may employ SQL (Structured Query Language).

The database 111 may be indexed. For example, depending on the particular implementation of this invention, the index may comprise a non-clustered index, clustered index, bitmap index, dense index, sparse index, reverse index, covering index, or inverted index (e.g., a record level inverted index or word level inverted index). Also, for example, the database maintenance engine 117 may create index terms by extracting data from different fields (e.g., metadata, headings, title, or page content) of knowledge objects stored in the database.

More generally, the DBMS 117 may determine relationships among data in the database 111, and may store data regarding those relationships in the database 111. For example, the DBMS 117 may determine relationships (a) among human experts and knowledge objects, (b) among human users of the system, or (c) among knowledge objects, and in each case may store data about these relationships in the database 111.

A variety of database models may be used. For example, depending on the particular implementation of this invention, the DBMS 117 may support a document model, relational model, object-enhanced relational model, hybrid database model, post-relational model, graph model, multivalue model, object-oriented model, hierarchical model, network model, or inverted file model.

The DBMS 117 may create data structures. Each of these data structures, respectively, may comprise an electrical circuit.

The DBMS 117 may be supplemented with stored procedures (i.e., executable code associated with the database 111). For example, the stored procedures may perform collect or customize common procedures (e.g., inserting a tuple into a relation), gathering statistical information about usage patterns, or performing complex logic or calculations.

The data stored in the database 111 may include knowledge objects. For example, a knowledge object (KO) may comprise a document or object (e.g., a PDF, Word®, Excel®, Powerpoint®, XML, YAML, JSON or BSON document or object), answer to a question, solution to a problem, article (e.g., blog article or Wiki article), news report, status update, photograph, video clip, visual content, audiovisual content, review, comment, or request for a knowledge object.

Metadata or attributes associated with a knowledge object (KO) may include, among other things: title, authorship, tags or key words, derivation, preview, signal of quality, and hits. A preview may comprise a summary, preview, or snapshot of the knowledge object. A signal of quality may comprise, for example, number of hits, number of votes (thumb-ups) received, or number of citations. Derivation of a specified KO is data regarding whether the specified KO is derived from another KO, or whether another KO is derived from the specified KO. For example, a later KO may be derived from a prior KO if the later KO incorporates content from the prior KO, or if the later KO is a revision or amendment of the prior KO. For example, by tracking derivation relationships, knowledge objects can be organized as a connected graph, on which each knowledge object is represented as a node. Knowledge objects may be related to each other. For example: (a) a first KO may be a review of a second KO; (b) a first KO and a second KO may have the same author or at least one common co-author; (c) a first KO may be derived from a second KO; or (d) or a first KO may have share a common tag or key word with a second KO.

The user interface 119 may receive inputs from human users of the knowledge processing system (KPS) and may produce outputs that are perceptible to the human users. A human user may employ the user interface 119 to search data in the database. The user interface 119, when used for searching the database, may have a look and feel similar to a conventional search engine for a Web browser, except that the data being searched are knowledge objects in the knowledge database, rather than web pages on the Internet. The user interface 119 (and the database management system 117 and database 111) may be employed by a user to perform, in addition to basic searches, advanced searches such as Boolean operator searches, proximity searches, concept-based searches (using statistical analysis of words in the knowledge objects), searches limited to a specified date range, and natural language queries. Search results may be ranked according to one or more ranking criteria. For example, the ranking criteria may include the expertise ranking of the expert who contributed the knowledge object, how many times the knowledge object has been hit (e.g., viewed) or cited, and may depend on the personal search history of person requesting the information.

More generally, the knowledge processing system may use any type of information retrieval technique, including any one or more of: (1) a set-theoretic model (e.g., representing a knowledge object as sets of words and phrases); (2) an algebraic model (e.g., representing knowledge objects and queries as vectors, matrices or tuples); (3) a probabilistic model (using probabilistic inference for retrieval); (4) a feature-based retrieval model (representing a knowledge object as a vector of feature functions); or (5) a standard Boolean model, extended Boolean model, fuzzy retrieval, vector space model, generalized vector space model, latent semantic indexing, binary independence model, probabilistic relevance model, uncertain inference, language model, divergence-from-randomness model, or latent Direchlet allocation. Furthermore, the KPS may employ an information retrieval model without term-interdependencies, with immanent term interdependencies, or transcendent term interdependencies.

The Inference Engine 113 may perform computer reasoning about data in a database using, for example, propositional logic (or zeroeth order logic), predicates of order 1 or more, epistemic logic, modal logic, temporal logic, fuzzy logic, or probabilistic logic (e.g., implemented in a Bayesian network) In addition, the Inference Engine 113 may employ the user interface 119 to communicate with human users.

In exemplary implementations, the Knowledge Acquisition Engine 115 may perform decentralized knowledge acquisition from human users. In this decentralized knowledge acquisition, the Knowledge Acquisition Engine 115 (through the user interface 119) interacts with users such that: (1) human users can generate queries (thereby determining the knowledge to be acquired) and (2) human experts can provide answers to the queries. Typically, the answers comprise knowledge that is missing from the knowledge database. The KPS may add the data in the answers to the knowledge base and index it.

This decentralized knowledge acquisition can respond flexibly to needs of the human users of the KPS—acquiring knowledge that the users actually want, rather than in accordance with some “central master plan” that is imposed top down.

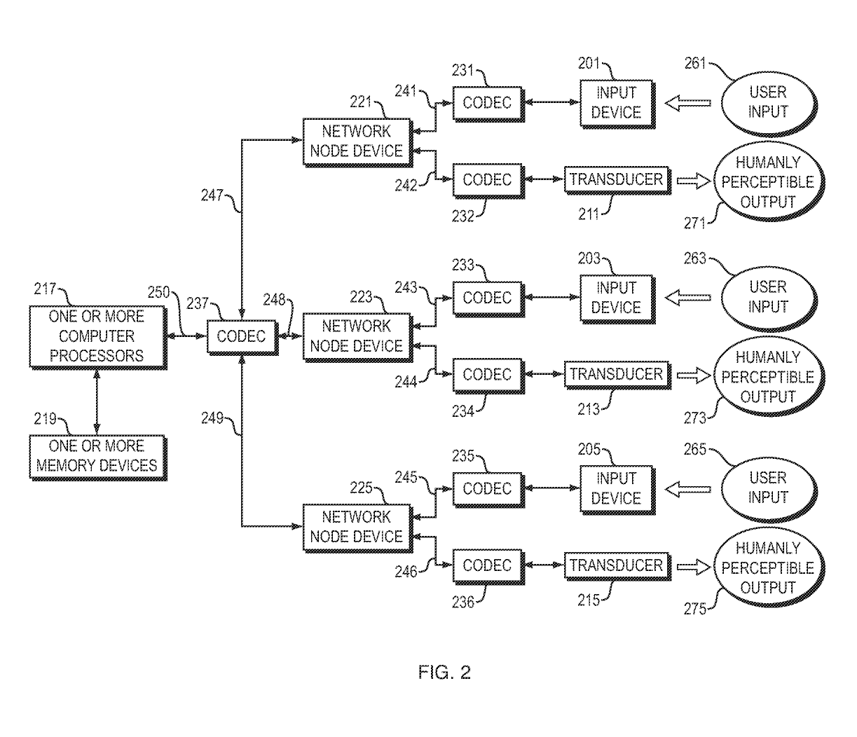

FIG. 2 shows hardware components of a knowledge processing system, in an illustrative implementation of this invention. One or more input devices (e.g., 201, 203, 205) receive input (e.g., 261, 263, 265) from human users of the KPS. For example, an input device (e.g., 201, 203, or 205) may comprise a keyboard, mouse, touchscreen, stylus, microphone, button, dial, joystick, pointing device, scanner, barcode reader, camera, eye gaze tracker, laser rangefinder, light sensor, pressure sensor, magnetic sensor, voltmeter, ammeter, or any other sensor that receives, or is configured to receive, input from human users. The input devices may output data or control signals.

The data or control signals from the input devices may be transmitted by wired or wireless transmission through a network to one or more computer processors 217. The network may include one or more network node devices (e.g., 221, 223, 225). For example, a network node device (e.g., 221, 223, or 225) may comprise a router, network switch (e.g., a layer 1 switch, layer 2 switch, layer 3 switch, layer 4 switch, unmanaged switch, managed switch, or smart switch), network bridge, network hub, or network repeater.

Codecs (e.g., 231, 232, 233, 234, 235, 236, 237) may encode information before it is transmitted through the network, or decode information after it is transmitted through the network. For example: (a) a codec (e.g., 231, 233, or 235) may encode information in signals outputted by an input device (e.g., 201, 203, or 205) before the information is transmitted through the network to the one or more processors 217; (b) a codec (e.g., 232, 234, or 236) may decode information contained in signals transmitted through the network from the one or more processors 217, and then output the decoded information to a transducer (e.g., 211, 313, or 215); (c) a codec 237 may encode information in signals outputted by the one or more processors 217, before the information is transmitted through the network to a transducer (e.g., 211, 313, or 215); or (d) a codec 237 may decode information contained in signals transmitted through the network from an input device (e.g., 201, 203, or 205), and then output the decoded information to the one or more processors 217.

The data may be transmitted through the network over one or more communication channels (e.g., 241, 242, 243, 244, 245, 246, 247, 248, 249). For example, a communication channel (e.g., 241, 242, 243, 244, 245, 246, 247, 248, or 249) may comprise a copper (or other metal) wire, an optical fiber, or a wireless communication channel. The data may be transmitted in a digital bit stream. The data may be represented as an electromagnetic signal, such as an electrical voltage, radiowave, microwave or infrared signal.

The one or more computer processors 127 may be housed in or comprise one or more computers. The one or more processors 127 may (i) process data, (ii) perform calculations, computations and computer logic, including performing computer reasoning by the Inference Engine 113, executing software instructions for the database management system 117, and executing software instructions for the Knowledge Acquisition Engine 115 (including for a reinforcement subengine 325, 400), (iv) cause data to be stored in memory devices 219, and (v) output signals to control transducers (e.g., 211, 313, 215). All computational or processing activities by the one or more processors may comprise execution of software instructions. The software instructions may be encoded, in whole or in part, in non-transitory machine-readable media. The one or more processors 217 may comprise one or more computers, including host servers or client computers. The processors may be are linked to other electronic hardware. Each of the one or more processors, network node devices, input devices, transducers and any other electronic devices connected by the network may be linked, including by a wired or wireless connection, with any one or more other devices. The one or more computer processors may be arranged in any physical or network configuration, including at a distance from each other or at a distance from the network. The network may be used to gather data about the state of the KPS.

One or more transducers (e.g., 211, 213, 215) produce humanly perceptible outputs (e.g., 271, 273, 275). For example, a transducer may comprise a electronic display screen, other light source speaker, earphone, or tactile transducer (which converts electricity to vibrations). One or more transducers (e.g., 211, 213, 215) may comprise a graphical user interface. A transducer (e.g., 211, 213, or 215) may include a light source (e.g., an LED, cathode ray tube, or fluorescent or incandescent light source).

One or more memory devices 219 may be employed to store data, including data in the database 111. For example, the memory devices 219 may include volatile memory devices (e.g., RAM, DRAM, or SRAM devices, including caches or buffers) or non-volatile memory devices (e.g., ROM, PROM, EPROM, EEPROM, FRAM, MRAM, or flash). Also, for example, the one or more memory devices 219 may include primary storage, secondary storage, tertiary storage, off-line storage, or near-line storage devices. Also, for example, the one or more memory devices 219 may include addressable semiconductor memory, hard disks, magnetic tapes, floppy disks, or optical discs. Also, for example, the one or more memory devices 219 may include devices that are electrically addressed or devices that are mechanically addressed (e.g., with a “head” or contact structure).

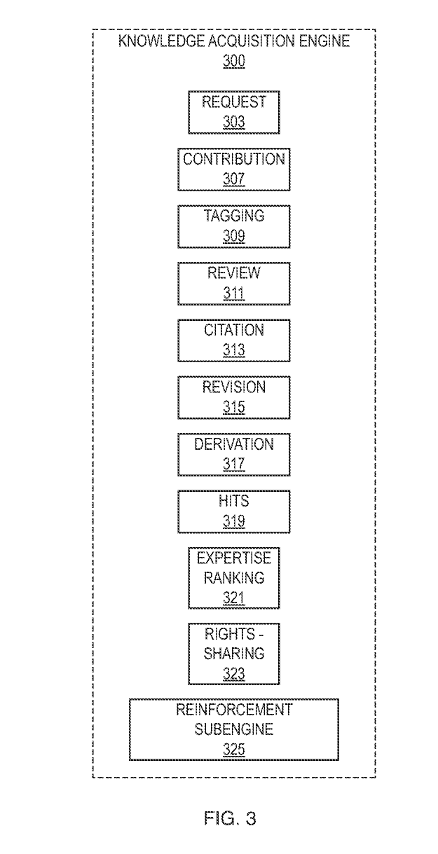

FIG. 3 shows an overview of a knowledge acquisition engine (“KAE”), in an illustrative implementation of this invention. The KAE 300 may be employed for decentralized knowledge acquisition, in which knowledge is acquired from human experts. The KAE 300 may include any combination of the following subengines: request for knowledge subengine 303, contribution of knowledge subengine 307, tagging subengine 309, review subengine 311, citation subengine 313, revision subengine 315, derivation subengine 317, hits subengine 319; expertise ranking subengine 321, rights-sharing subengine 323, and reinforcement subengine 325.

The request for knowledge subengine 303 may receive an input (a “request input”) from a human user (the “requesting user”) that requests information. The request input may specify (a) the specific information requested, or (b) a type or class of information requested. In addition, a knowledge request may specify (c) the addressees (users to whom the request is to be made), (d) a preferred or required format for the requested knowledge, (e) names or other information regarding a user or users who are making the request, and whether such information may be disclosed to other users in connection with the request for information, (f) a deadline for responding to the request, or (g) any other parameter or attribute of a knowledge request. For example, the request input may specify whether the request for information is to be made to (i) all human users of the system, (ii) a class of human users of the system (e.g., users with an expertise ranking of at least a specified rank in a specified field), or (iii) to individuals specified by the requesting user. The request for knowledge subengine 303 may: (a) cause the request, including metadata or attributes, to be stored in a memory device, and (b) based on the request input, cause one or more communications (“request communications”) to be sent to one or more addressees (users of the system). The request communications may include all or part of the data in the request input.

The contribution of knowledge subengine 307 may receive an input (a “contribution input”) from a human user (a “contributing user”) that contributes information (“contributed information”). The contribution input may include a knowledge object being contributed (e.g., a document, solution, or answer). The contribution input may also specify (a) whether the contribution is unsolicited or is in response to a knowledge request, (b) if the latter, the identity of the knowledge request, (c) the type or class of the contributed information requested, (d) the format of the contributed information, (e) names or other information regarding authors who created the contributed information or regarding contributors who contributed the contributed information to the KPS, or (f) any other parameter or attribute of the contributed information. The contribution of knowledge subengine 307 may: (a) cause a contributed knowledge object, including metadata or attributes, to be stored in a memory device, and (b) based on the contribution input, cause one or more communications (“contribution communications”) to be sent to one or more addressees (users of the system). The contribution communications may (i) convey all or part of the contributed information or (ii) may include a notice that the contributed information has been added and information (or a link) regarding how to access the contributed information. The contribution communications may include all or part of the data in the contribution input.

As used herein: (a) “KO” means a knowledge object; (b) an “author” of a KO means a user who creates the KO (e.g., a human who writes an academic paper); and (c) a “contributor” of a KO means a user who inputs the KO into the KPS (e.g., by uploading or scanning a document) or who points out a KO. A contributor of a KO may be, but is not necessarily, an author of the KO.

The tagging subengine 309 may receive an input (a “tagging input”) from a human user (a “tagging user”) that tags a knowledge object already stored in the KPS. The tagging input may specify: (a) the knowledge object to be tagged; or (b) the content of the tag (e.g., a key word or other tag).

The review subengine 311 may receive an input (a “review input”) from a human user (a “reviewing user”) that reviews a knowledge object already stored in the KPS. The review input may include a document or other knowledge object that comprises the review. The review input may also specify (a) names or other information regarding authors who create the review or regarding contributors who contribute the review to the KPS, and whether such information may be disclosed to other users in connection with the review, or (c) any other parameter or attribute of a review. The review subengine 311 may cause the review to be associated with the knowledge object being reviewed. Also, the review subengine 311 may: (a) cause the review, including metadata or attributes, to be stored in a memory device, and (b) based on the review input, cause one or more communications (“review communications”) to be sent to one or more addressees (users of the system). The review communications may (i) convey all or part of the review or (ii) may include a notice that the review has been added and information (or a link) regarding how to access the review. The review communications may include all or part of the data in the review input.

The citation subengine 313 may receive an input (a “citation input”) from a human user (a “citation user”), which input includes data regarding a citation of a knowledge object already stored in the KPS. The citation input may specify (a) the content of the citation, (b) the knowledge object that is being cited, (c) the knowledge object in which the citation appears, (d) names or other information regarding authors who create the citation or regarding contributors who contribute the citation to the KPS, and whether such information may be disclosed to other users in connection with the citation, or (e) any other parameter or attribute of a citation. The citation subengine 313 may cause the citation to be associated with (i) the knowledge object being cited and (ii) the knowledge object in which the citation occurs. Also, the citation subengine 313 may: (a) cause a citation, including metadata or attributes, to be stored in a memory device, and (b) based on the citation input, cause one or more communications (“citation communications”) to be sent to one or more addressees (users of the system). The citation communications may (i) convey all or part of the citation or (ii) may include a notice that the citation has been added and information (or a link) regarding how to access the citation. The citation communications may include all or part of the data in the citation input.

The revision subengine 315 may receive an input (a “revision input”) from a human user (a “revision user”), which input includes data regarding a revision of a knowledge object already stored in the KPS. The revision input may specify or include (a) the content of the revision, (b) the knowledge object that is being revised, (c) names or other information regarding authors who create the revision or regarding contributors who contribute the revision to the KPS, and whether such information may be disclosed to other users in connection with the revision, or (e) any other parameter or attribute of a revision. The revision subengine 315 may: (a) cause a revision, including metadata or attributes, to be stored in a memory device, and (b) based on the revision input, cause one or more communications (“revision communications”) to be sent to one or more addressees (users of the system). The revision communications may (i) convey all or part of the revision or (ii) may include a notice that the revision has been added and information (or a link) regarding how to access the revision. The revision communications may include all or part of the data in the revision input.

The derivation subengine 317 may track derivative use of knowledge objects (KOs). For example, derivative use of an earlier knowledge object (“parent KO”) may comprise (i) incorporation of any content from the parent KO into a later knowledge object (“derivative KO”), or (ii) revision of the parent KO to create a revised KO, which is a derivative KO. Also, the derivation subengine 317 may determine derivative use over multiple “generations” of knowledge objects. (For example, the derivation subengine 317 may determine that a parent KO has a derivative KO, and that the derivative KO is itself a parent KO and has a derivative KO). The derivation subengine 317 may also track the authors or contributors of knowledge objects. The derivation subengine 317 may cause data regarding derivative use, authors and contributors to be stored in memory.

The hits subengine 319 may track hits on a knowledge object (i.e., any downloading, streaming, visual display or audible playing of the knowledge object). For example, the hits subengine 319 may keep a record of each time that a knowledge object (KO) is hit, including data regarding when the hit occurred, by whom, and in what manner. Also, for example, the use subengine 319 may track hits on a derivative KO (e.g., viewing of derivative KO), and associate the use of the derivative KO with the parent KO.

The expertise ranking subengine 321 may calculate an expertise ranking for human users of the system. For example, the expertise ranking of a human expert may be general or may be in a particular field of knowledge. Also, for example, the expertise ranking may be determined based on (among other things) one or more of: (a) number of KOs contributed by the human expert generally or in a particular field; (b) how long ago the human expert contributed the KOs; (c) reviews by other users of KOs contributed by the human expert; (d) hits on KOs contributed by the human expert; (e) citations of KOs contributed by the human expert, (f) reviews by other users of the human expert, including input from other users regarding the expertise ranking of the expert generally or in a specific field of knowledge; and (g) input from a KPS system administrator regarding the expertise ranking of the expert generally or in a specific field of knowledge (e.g., the input from the administrator may comprise prior knowledge or knowledge obtained from external sources). As used herein, every user of the KPS is an “expert” with an expertise ranking The expertise ranking of an “expert” can be as low as zero (for no expertise).

The rights-sharing subengine 323 may track user rights in a knowledge object. For example: (a) the right to view, play, download, stream, or revise a knowledge object may be limited to a set of users of the KPS; and (b) a contributor of the knowledge object may share (e.g., transfer) rights in the knowledge object.

The reinforcement subengine 325 may provide positive reinforcers to encourage certain conduct by human users. The reinforcement subengine 325 may also provide negative reinforcers to discourage other conduct.

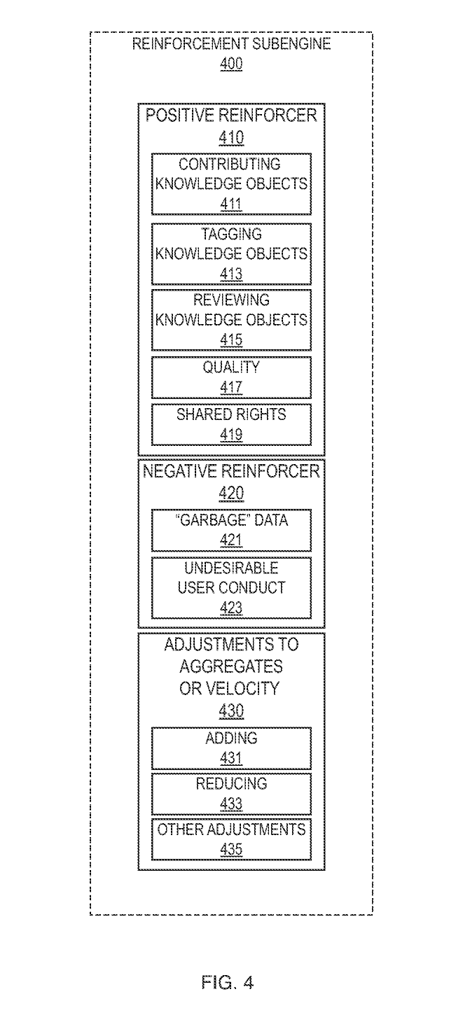

FIG. 4 shows an overview of a reinforcement subengine, in an illustrative implementation of this invention. The reinforcement subengine 400 includes a positive reinforcer sub-subengine 410 that may control positive reinforcement of certain user behaviors (e.g., behaviors such as contributing knowledge objects 411, tagging knowledge objects 413, reviewing knowledge objects 415, and submitting “high quality” knowledge objects 417). In addition, the positive reinforcer 410 may encourage other users to obtain shared rights in a knowledge object and to work to improve that knowledge object 419.

The reinforcement subengine 400 also includes a negative reinforcer sub-subengine 420 that may control negative reinforcement of certain user behaviors (e.g., behaviors such as contributing “garbage” data 421, or other undesirable user conduct 423).

The reinforcement subengine 400 may employ a variety of different reinforcers to encourage or discourage certain behaviors. For example, the positive reinforcers may comprise: (a) enhancing the status of a user (e.g., assigning a high expertise ranking to the user, and prominently or frequently communicating that high expertise to other users of the system), or (b) increasing the power of a user within the KPS (e.g., increasing editorial control by the user over certain knowledge objects or classes of knowledge objects).

Also, for example, a reinforcer may be a “transferable reinforcer unit” or “TRU”—that is, a reinforcer that is transferable from one user to another, fungible, and exists in discrete units or quantities. For example, a TRU may comprise reward points or bonus points used internally within the KPS. Or, for example, a TRU may comprise a virtual currency. In illustrative implementations of this invention: (a) units of a virtual currency are TRUs; (b) the virtual currency is used internally within the KPS; and (b) this KPS virtual currency is not a “real-world” currency used in the external “real world”.

As noted above, the Knowledge Acquisition Engine 115 may perform decentralized knowledge acquisition, in which information is received from human experts.

An initial hurdle, when performing such decentralized knowledge acquisition, is to get human experts to even read a request for information. The KPS may encourage human experts to read (or otherwise pay attention to) requests for information, even if the experts do not provide an answer to the query. For example, a request for information may be accompanied by an offer to pay users (in a KPS virtual currency) to merely read (or otherwise pay attention to) the query. Paying attention to content may comprise downloading, streaming, displaying visibly or playing audibly the content.

Another hurdle, when performing the decentralized knowledge acquisition, is to get a human expert to actually respond to a query by providing the requested information. The KPS may encourage human experts to provide knowledge objects in response to queries. For example, a human user may employ the KPS to make a query, and may accompany the query with an offer to pay users (in the KPS virtual currency) for inputting knowledge in response to the query.

In some cases, a user requesting information may not offer to pay for it. In that case, the KPS may employ other techniques to encourage experts to actually respond to the query. These techniques may involve payments in a KPS virtual currency by a KPS Facilitator. The “KPS Facilitator” is (a) a virtual persona such as a virtual administrator, planner, banker, mascot, leader, or other virtual individual who personifies the KPS; or (b) a virtual entity such as a virtual bank, central bank, reserve bank, house account or other virtual entity who personifies the KPS. In the case of a payment to a human user by the KPS Facilitator, the KPS may be effectively “minting” units of the KPS virtual currency or may be transferring units of the KPS virtual currency from an a KPS Facilitator account.

Even if a user requesting information is not willing to pay for an answer, a user's request for information may, at least in some cases, be accompanied by an offer by the KPS Facilitator to pay (in the KPS virtual currency) for an answer. In typical practice, such an offer, if made by the KPS Facilitator, would be limited to only certain experts and would in a relatively small amount.

In the case of any offer to pay (in the KPS virtual currency) for an answer or for attention: (i) the offer may be addressed to all or less than all of the users of the KPS, and (ii) the price offered may vary depending on the person receiving the offer. For example, the offer may be made only to users with certain expertise rankings, and the price offered may vary depending on the expertise rankings of the users receiving the offer.

In addition, the KPS may encourage human experts to provide an answer even if neither the Facilitator nor a requesting user offers to pay for it. For example, the KPS Facilitator may pay (in the KPS virtual currency) for use of a knowledge object. Use of a specified knowledge object may comprise, for example, any: (i) user attention to any content in the specified knowledge object (e.g., downloading, streaming, displaying visibly or playing audibly the content), (ii) citation to the specified knowledge object, or (iii) derivative use of the specified knowledge object. For example, derivative use may comprise incorporation of any content from the specified knowledge object into any other knowledge object, or (iv) revision of the specified knowledge object by any other user of the system. If one or more other experts revise the knowledge object, then the KPS may allocate the use payment among the original author and the subsequent revising authors. In addition, the KPS Facilitator may impose a policy that, if a subsequent answer to a query is derived in part from a prior knowledge object (a “parent KO”), then all or certain payments with respect to the derived knowledge object (the “derivative KO”) must be shared in part with the author of the parent KO. For example, a derivative knowledge object may be copied in part from the parent KO or may be a revision of a parent KO. Also, for example, the types of payments required to be shared with the author of the parent KO may include a payment by a requesting user for an answer, where the derivative KO is the answer.

Another hurdle, in the decentralized knowledge acquisition, is to encourage human experts to contribute “high quality” data, rather than “garbage data”. The KPS may encourage experts to provide high quality data in a number of ways. For example, the KPS Facilitator may impose a policy whereby: (A) after a requesting user offers to pay for an answer and one or more human experts provide knowledge objects in response to the offer, the requesting user may review the knowledge objects that are submitted; (B) the requesting user may determine how to allocate all or part of the offered price among the experts who responded; (C) the requesting user may determine that the knowledge objects submitted in reply are not fully responsive and that less than all of the price offered shall be paid, in aggregate; and (D) payments (in KPS virtual currency) for the contributed objects are made in accordance with these determinations by the requesting user. Alternately, KPS Facilitator may allow sharing of rights to receive payments. For example, rights to receive payment for hits on a specified knowledge object may be shared. For example, rights with respect to a knowledge object (e.g., to control editing or to receive payments) may be transferable and divisible. For example, a user who contributes a specified knowledge object may transfer all of part of his right to receive a payment (e.g., for hits on the specified knowledge object or on KOs derived from it) to one or more other users. These other users would then have a reason to improve the specified knowledge object.

Also, for example, high quality knowledge objects tend to have more hits, and thus generate payments for hits.

In addition, “crowd-sourced” data may be used to detect the submission of “garbage data” and other undesirable conduct by users (e.g., users exploiting a loophole in a KPS policy in order to obtain payments in virtual currency). For example, KPS users may be allowed on an ongoing basis to report other KPS users who submit garbage data or who engage in undesirable conduct. In addition, the KPS Facilitator may from time to time give notices to users encouraging them to provide such reports. The KPS Facilitator may, in response to reported instances or patterns of submitting “garbage data” (or other undesirable conduct), actively discourage such behavior by the offending user. For example, the KPS Facilitator may impose a fine or penalty (in KPS virtual currency) for such behavior. The fine or penalty may be deducted from a payment otherwise due the offender, or may be achieved by a deduction from the offender's account.

Another hurdle, in the decentralized knowledge acquisition, is to provide sufficiently strong encouragement to experts to provide answers. The KPS may do this in a variety of ways. For example, a human expert may not be willing to answer a query for free or for the price (in KPS virtual currency) offered by the requesting user. In that case, the human expert may use the KPS to offer to provide information (e.g., answer a question) for a certain price, which is higher than the price, if any, offered by the requesting user. A requesting user may use the KPS to see a preview of the contents that the expert is proposing to submit, before accepting the expert's offer. In addition, a requesting user may use the KPS to review an expertise ranking of the expert and other information about the expert that the expert has consented to share.

Another hurdle, in the decentralized knowledge acquisition, is to encourage users to tag or review knowledge objects. The KPS Facilitator may pay users (in KPS virtual currency) for tagging or reviewing a knowledge object. The amount of payment for a review may depend on: (1) the expertise ranking of the reviewer or (2) any other factor that may affect the amount paid for contribution of a knowledge object (a review being a special case of a knowledge object).

Another hurdle, in the decentralized knowledge acquisition, is that: If KPS virtual currency) is used, then a velocity or aggregate level of the KPS virtual currency may need to be adjusted. For example, deflation or undesirably rapid inflation may occur, or the velocity of the KPS virtual currency may too slow (e.g., the KPS virtual currency may not be changing hands rapidly enough). The reinforcer sub-engine 400 may make adjustments to a velocity or aggregate level of KPS virtual currency 430. For example, the reinforcer sub-engine 400 may add KPS virtual currency to the KPS, or adjust the rate at which the KPS virtual currency is added or to adjust the amount of such additions. For example, KPS virtual currency may be added to the KPS 431 (thereby increasing an aggregate level of the KPS virtual currency) when the KPS Facilitator: (a) seeds a new user's account with an initial starting amount of KPS virtual currency; (b) periodically replenishes an existing user's account with an amount of KPS virtual currency; (c) pays a user (in KPS virtual currency) for tagging or reviewing a knowledge object; (d) pays a contributor (in KPS virtual currency) for contributing a knowledge object; or (e) pays a contributor (in KPS virtual currency) for hits on a knowledge object. For example, KPS virtual currency may be removed from the KPS 433 (thereby reducing an aggregate level of the KPS virtual currency) when: (a) a unit of KPS virtual currency expires, or (b) the KPS Facilitator fines a user for contributing “garbage” data or for engaging in other undesirable conduct.

For example: (a) an input (e.g., 261, 263, or 265) may comprise a request input, an output (e.g., 271, 273, or 275) may comprise a request communication, and the request input may specify an amount (in KPS virtual currency) that the requesting user is offering to pay for requested information; (b) an input (e.g., 261, 263, or 265) may comprise a contribution input, an output (e.g., 271, 273, or 275) may comprise a contribution communication, and an output (e.g., 271, 273, or 275) may comprise a communication regarding payment (in KPS virtual currency) for the contribution; (c) an input (e.g., 261, 263, or 265) may comprise a tagging input, and an output (e.g., 271, 273, or 275) may comprise a communication regarding payment (in KPS virtual currency) for the tag; (d) an input (e.g., 261, 263, or 265) may comprise a review input, an output (e.g., 271, 273, or 275) may comprise a review communication, and an output (e.g., 271, 273, or 275) may comprise a communication regarding payment (in KPS virtual currency) for the review; (e) an input (e.g., 261, 263, or 265) may comprise a citation input, an output (e.g., 271, 273, or 275) may comprise a citation communication, and an output (e.g., 271, 273, or 275) may comprise a communication regarding payment (in KPS virtual currency) for the citation; (f) an input (e.g., 261, 263, or 265) may comprise a revision input, an output (e.g., 271, 273, or 275) may comprise a revision communication, and an output (e.g., 271, 273, or 275) may comprise a communication regarding payment (in KPS virtual currency) for the revision; (g) an input (e.g., 261, 263, or 265) may comprise an offer by an expert to provide information for a price (in KPS virtual currency); and an output (e.g., 271, 273, or 275) may comprise a communication of that offer to other users; and (h) an input (e.g., 261, 263, or 265) may comprise a request by a user for a preview of a knowledge object, and an output (e.g., 271, 273, or 275) may comprise a communication of that preview to a user who requested the preview.

The one or more processors 217 may apply computer reasoning to determine actions to adjust a velocity or aggregate level of the KPS virtual currency. These actions may add to a monetary supply 431, reduce a monetary supply 433, or comprise an adjustment other than increasing or decreasing a monetary supply 435. For example, the one or more processors 217 may apply computer reasoning to: (a) adjust how long it takes for units of the virtual currency to expire, thereby adjusting velocity, (b) adjust the amount or frequency of periodic replenishments (in KPS virtual currency) of user accounts, (c) adjust the amount or frequency of payments (in KPS virtual currency) for hits on knowledge objects, (d) adjust the amount of payments (in KPS virtual currency) for contribution, tagging or review of knowledge objects, or (e) adjust the amount (in KPS virtual currency) of fines or any other parameters of fines, including how frequently fines are assessed and for what conduct.

When applying computer reasoning to determine actions to adjust a velocity or aggregate level of the KPS virtual currency, the one or more processors 217 may control the user interface 119 to engage in dialogue with a human administrator of the KPS. For example, the dialogue may include the user interface 119 outputting humanly perceptible output (e.g., 271, 273, or 275) that comprises a visual display (or other communication) of data regarding current or past states of the KPS, such as data regarding velocity or aggregate levels of KPS virtual currency, data regarding various classes of events involving KPS virtual currency (e.g., payments for attention, contribution, tagging or use), data regarding expiration dates, data regarding amounts held in various accounts (e.g., user accounts) or classes of accounts, or data regarding prior or ongoing adjustments and impact of prior or ongoing adjustments. The data may be expressed in units of the KPS virtual currency or in any other units (e.g., units of a “real world”, external currency). Also, the one or more processors 217 may apply computer reasoning to calculate (i) a monetary aggregate of a virtual currency in the knowledge processing system, (ii) an optimal value of the monetary aggregate to optimize one or more parameters of the knowledge processing system, and (iii) one or more monetary supply actions. For example, optimization may be calculated using any optimization algorithm, including a simplex algorithm for linear programming, an extension of the simplex algorithm for quadratic programming or for linear-fractional programming, or a combinatorial algorithm. A wide variety of parameters may be optimized by the optimization program, including number of knowledge objects contributed by experts with at least a specified level of expertise, or aggregate value of knowledge objects in the system (expressed in units other than units of the virtual currency).

The dialogue may further include user interface 119 (i) outputting humanly perceptible output (e.g., 271, 273, or 275) that comprises a request for data or instructions from the human administrator, and (ii) receiving input (e.g., 261, 263, or 265) from the human administrator comprising such data or instructions. The one or more processors 217 may apply computer reasoning to such data or instructions from a human administrator in subsequent calculations to determine actions to adjust a velocity or aggregate level of the KPS virtual currency.

This computer reasoning may be performed by the Inference Engine 113. The Inference Engine 113 may be well-suited for this task, because of its ability to handle complex calculations involving dialogue with a human administrator.

The Source Code comprises source code for software used in an illustrative implementation of this invention. This software is one example, out of many, of how software for this invention may be written.

This invention has many practical applications. For example, the knowledge processing system may (in illustrative implementations) be used to acquire and share knowledge in the following applications, among others: (a) an online knowledge acquisition tool provided over the Internet, administered by a not-for-profit institution and accessible for free by the public; or (b) a knowledge acquisition tool provided free to students, teachers, and staff at a state university.

### Definitions and Clarifications

Here are a few definitions and clarifications. As used herein:

The terms “a” and “an”, when modifying a noun, do not imply that only one of the noun exists.

The term “codec” shall be construed broadly. For example, a codec may comprise any apparatus that: (a) encodes (or is configured to encode) data or a signal; (b) decodes (or is configured to decode) data or a signal, or (c) that transforms data or a signal from one format, form or representation to another format, form or representation. For example, a codec may encode a data stream for transmission or storage.

The term “comprise” (and grammatical variations thereof) shall be construed broadly, as if followed by “without limitation”. If A comprises B, then A includes B and may include other things.

The term “computer reasoning” shall be construed broadly. For example, “computer reasoning” may (a) comprise propositional logic (or zeroeth order logic), logic with predicates of order 1 or more, epistemic logic, modal logic, temporal logic, fuzzy logic, probabilistic logic (e.g., implemented in a Bayesian network) or any other logic, (b) any algorithm, computer software, or computer program, including any algorithm that transforms one or more inputs of the algorithm into one or more outputs of the algorithm, and (c) execution by a computer of any of the foregoing (including execution of any logic, algorithm, software or program).

The term “communication” shall be construed broadly. For example, a display of content on an electronic display screen may comprise a communication to a user, even if the display of content does not occur until the user accesses a particular page or part of a page of a network site.

The term “comprise” means include without limitation.

A transitory signal is not a “data structure”.

The terms “decode ” and “encode” shall be construed broadly, and are not limited to encryption.

The term “e.g.” means for example.

The fact that an “example” or multiple examples of something are given does not imply that they are the only instances of that thing. An example (or a group of examples) is merely a non-exhaustive and non-limiting illustration.

Unless the context clearly indicates otherwise: (1) a phrase that includes “a first” thing and “a second” thing does not imply an order of the two things (or that there are only two of the things); and (2) such a phrase is simply a way of identifying the two things, respectively, so that they each can be referred to later with specificity (e.g., by referring to “the first” thing and “the second” thing later). For example, unless the context clearly indicates otherwise, if an equation has a first term and a second term, then the equation may (or may not) have more than two terms, and the first term may occur before or after the second term in the equation. A phrase that includes “a third” thing, a “fourth” thing and so on shall be construed in like manner.

A “hit” on a knowledge object means downloading, streaming, visual display or audible playing of the knowledge object.

The term “inference engine” shall be construed broadly. For example, the term “inference engine” includes: (a) software instructions for applying computer reasoning to data; or (b) a computer processor that applies (or is configured to apply) computer reasoning to data.

The term “input device” shall be construed broadly. For example, an input device may comprise a keyboard, mouse, touchscreen, stylus, microphone, button, dial, joystick, pointing device, scanner, barcode reader, camera, eye gaze tracker, laser rangefinder, light sensor, pressure sensor, magnetic sensor, voltmeter, ammeter, or any other sensor that receives, or is configured to receive, input from human users. For example, an input device may output electromagnetic or optical signals that represent data or instructions.

A “knowledge processing system” means a system that stores (or is configured to store) data representing information in one or more memory devices and that applies (or is configured to apply) computer reasoning to the data.

The term “knowledge object” shall be construed broadly. For example, a knowledge object may comprise a document or object (e.g., a PDF, Word®, Excel®, Powerpoint®, XML, YAML, JSON or BSON document or object), answer to a question, solution to a problem, article (e.g., blog article or Wiki article), news report, status update, photograph, video clip, visual content, audiovisual content, review, comment, request for a knowledge object, or any other data or instantiation of information.

A transitory signal is not a “memory device”.

A “monetary aggregate” of a currency in a system means either: (a) the sum total of that currency in the system; (b) the sum of that currency held in a particular manner by users of a system. For example, M1 and M2 are monetary aggregates of money in the “real world” U.S. economy. A “velocity” of a currency in a system is a measure of a rate at which the currency is transferred or spent.

A “monetary supply action” is an event that changes (or directly or directly causes a change of, or comprises a change of) a monetary aggregate or velocity of a currency. The term “monetary supply action” does not include an exchange of (1) a virtual currency used in a KPS for (2) a currency that is used in the external “real world” and issued by a “real world” government.

The term “or” is inclusive, not exclusive. For example “A or B” is true if A is true, or B is true, or both A or B are true. Also, for example, a calculation of “A or B” means a calculation of A, or a calculation of B, or a calculation of A and B.

A parenthesis is simply to make text easier to read, by indicating a grouping of words. A parenthesis does not mean that the parenthetical material is optional or can be ignored.

The phrase “pay attention” shall be construed broadly. For example, paying attention to content may comprise (a) a human seeing, reading or hearing the content, or (b) any event (e.g., downloading, streaming, displaying visibly or playing audibly the content) that is positively correlated with such seeing, reading or hearing.

The term “preview” shall be construed broadly. For example, a preview of content may comprise a summary, preview, or snapshot of the content.

The term “review” shall be construed broadly. For example, a “review” of content may comprise a review, critique, comment, ranking, approval or disapproval of the content.

The term “such as” means including without limitation.

The term “transmission” shall be construed broadly, and is not limited to wireless. For example, transmission may occur through one or more of the following: a copper (or other metal) wire, an optical fiber, or a wireless communication channel. Language to the effect that data or signal is transmitted “from” a first point “to” a second point shall be construed broadly. For example, data that is transmitted from a first device to a second device through a network may pass through many intermediate devices in the network as it travels from the first to second device. Also, for example, transmission may be from a first device to a second device even if it is indirect.

The term “virtual currency” shall be construed broadly. For example, a currency can be a virtual currency even if it is sometimes represented by tangible physical objects. A phrase that indicates that a virtual currency is “used” in a system shall be construed broadly. For example, a virtual currency is “used” in a system if that system outputs content that depicts transactions (e.g., offers or payments) in that currency.

Unless the context clearly requires otherwise, any description of any computation by a computer (including any determination by a computer) shall be construed as a high-level description. For example, a single step of a high-level description may actually involve many steps of machine-level behavior in the computer, such as many steps of machine-code level computations, or many physical changes in logic voltage.

A list of multiple steps in a method (or process) does not imply, except to the extent that the context requires otherwise, that: (1) the steps occur in any particular order or sequence, including the order or sequence listed; (2) the steps occur only once; (3) the different steps occur the same number of times during the process, or (4) a particular step is applied to the same thing each time that the particular step occurs.

Grammatical variations of defined terms shall be construed in like manner as the defined terms. For example, if a verb is defined in one conjugation, then other conjugations of that verb shall be construed in like manner. Also, for example, if a noun is defined in one declension, then other declensions of that noun shall be construed in like manner. Also, for example, the phrase “transmission” shall be construed in like manner as “transmit”, and the verb “review” shall be construed in like manner as the noun “review”.

### Variations

This invention may be implemented in many different ways. Here are some non-limiting examples.

This invention may be implemented as a knowledge processing system comprising, in combination: (a) one or more memory devices for storing data representing information; (b) one or more computer processors for applying computer reasoning (i) to determine relationships among the data, and (ii) to calculate (A) a monetary aggregate of a virtual currency in the knowledge processing system, (B) an optimal value of the monetary aggregate to optimize one or more parameters of the knowledge processing system, and (C) one or more monetary supply actions; and (c) a plurality of input devices for receiving a set of inputs from human users of the system and a plurality of transducers for producing a set of outputs, such that (i) the set of inputs includes a first input and a second input, (ii) the set of outputs are humanly perceptible and include a first output, and (iii) the first input comprises an offer by a first user to pay a second user an offer price, in the virtual currency, if the second user pays attention to a first knowledge object.

This invention may be implemented as a method comprising, in combination: (a) one or more memory devices storing data in data structures; (b) one or more computers applying computer reasoning to calculate (i) a monetary aggregate of a virtual currency in a knowledge processing system, and (ii) one or more monetary supply actions; (c) a plurality of input devices receiving a set of inputs from human users; (d) a plurality of transducers producing a set of outputs; and (e) an encoder encoding data for transmission from an input device, out of the plurality of input devices, to a processor, out of one or more processors; wherein (i) the set of inputs includes a first input and a second input, (ii) the set of outputs are humanly perceptible and include a first output, (iii) the first input comprises an offer by a first user to pay a second user an offer price, in the virtual currency, if the second user pays attention to a first knowledge object, (iv) the first output comprises a communication of the offer to at least a second user, and (v) the second input comprises an instruction by a second user to download, stream, display visibly or play audibly, the first knowledge object. Furthermore: (1) the set of inputs that are received may include a communication indicative of a reviewer's review of a knowledge object, and the set of outputs that are produced may comprise a communication to the reviewer confirming payment for the review, which payment is to the reviewer and in the virtual currency; (2) the set of outputs may include a communication that specifies a certain monetary aggregate of virtual currency in the system, and that expresses the certain monetary aggregate in units other than units of the virtual currency; (3) the set of inputs that are received may include a tagging of a knowledge object by a certain user, and the set of outputs that are produced may include a communication to the certain user confirming payment for the tagging, which payment is to the certain user and is in the virtual currency; and (4) the set of inputs that are received may include inputs by a plurality of users indicating disapproval of a disapproved item, the disapproved item comprising an action or actions by a specific user or a knowledge object inputted by the specific user; and the set of outputs that are produced may comprise a communication to the specific user regarding a penalty, which penalty is against the specific user, is in the virtual currency, and is at least in part for the disapproved item.

This invention may be implemented as a method comprising, in combination: (a) one or more memory devices storing data in data structures; (b) one or more computers applying computer reasoning (i) to determine an expertise ranking of a particular user of a knowledge processing system; and (ii) to calculate (A) a monetary aggregate of a virtual currency in the knowledge processing system, and (B) one or more monetary supply actions; (c) a plurality of input devices receiving a set of inputs from human users; and (d) a plurality of transducers producing a set of outputs; wherein (i) the set of inputs that are received include a first input and a second input and the set of outputs that are produced include a first output, (ii) the first input comprises an offer by a first user to pay an offer price, in the virtual currency, for a first knowledge object, and the first output comprises a communication of the first offer to other users of the system, and (iii) the second input comprises an input of a first knowledge item by a second user of the system, in response to the first offer. Furthermore: (1) the set of inputs that are received may include a review by the first user, which review either (A) reviews the first knowledge object inputted by the second user, (B) reviews how responsive the first knowledge object is to the first offer, or (C) indicates what portion, if any, of the first price should be paid for the first knowledge object; (2) the set of outputs that are produced may include a communication to the second user indicating payment, which payment is in the virtual currency, is for the first knowledge object, and is in an amount less than the offer price; (3) the method may further comprise the one or more processors calculating an optimal value of the monetary aggregate to optimize one or more parameters of the knowledge processing system; (4) the set of inputs that are received may include a communication indicative of a particular offer by the second user to provide the requested knowledge object for a second price, which second price is higher than the first price, and the set of outputs that are produced may comprise a communication of the particular offer to at least the first user; (5) the set of outputs that are produced may include a communication of an expertise ranking of the second user; and (6) the set of inputs that are received may include an instruction by the first user to download, stream, display visibly or play audibly, preview content, the preview content comprising a part but not all of a knowledge object that the second user has inputted or specified.

This invention may be implemented as a method comprising, in combination: (a) one or more memory devices storing data in data structures; (b) a plurality of input devices receiving a set of inputs from human users; and(c) a plurality of transducers producing a set of outputs, each respective output, out of the set of outputs, being humanly perceptible and produced by at least one of the transducers; wherein (i) the set of inputs that are received includes a first input and a second input, and the set of outputs that are produced includes a first output, (ii) the first input comprises a request by a first user of the system for a requested knowledge object, and the first output comprises a communication of the request to other users of the system, (iii) the second input comprises an input of the requested knowledge item by a second user of the system, and (iv) the method further comprises one or more processors applying computer reasoning (A) to determine hits on the requested knowledge item, (B) to determine an amount of a certain payment to be made in the virtual currency, which amount depends at least in part on the hits, (C) to identify a set of users, each of whom have rights in the certain payment, which rights are either held by the second user or have been transferred directly or indirectly from the second user, and (D) to determine allocation of the certain payment among the set of owners, based at least in part on these rights. Furthermore: (1) the method may further comprise the one or more processors applying computer reasoning to calculate (i) an existing or prior monetary aggregate of a virtual currency in the knowledge processing system, and (ii) one or more monetary supply actions; (2) the monetary supply actions may comprise paying the virtual currency for tagging or reviewing knowledge objects; (3) the monetary supply actions may comprise paying an identical amount of the virtual currency to each respective user of the system; (4) the method may further comprise the one or more processors calculating an optimal value of the monetary aggregate to optimize one or more parameters of the knowledge processing system; (5) units of the virtual currency may expire within a certain time period after being created; and (6) the one or more processors may apply computer reasoning: (a) to determine hits on a second knowledge object, which second knowledge object either (i) includes content copied from the requested knowledge object, or (ii) is a revision of the requested knowledge object; and (b) to calculate an amount of a payment in the virtual currency, which amount depends at least in part on the hits.

This invention may be implemented with TRUs other than the virtual currency. For instance, each example above involving a virtual currency may instead be implemented with a TRU other than a virtual currency.

### Conclusion

While exemplary implementations are disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention. Numerous modifications may be made by one of ordinary skill in the art without departing from the scope of the invention.

What is claimed:

1. A knowledge processing system comprising, in combination:
(a) one or more memory devices for storing data representing information;
(b) one or more computer processors for applying computer reasoning (i) to determine relationships among the data, and (ii) to calculate (A) a monetary aggregate of a virtual currency in the knowledge processing system, (B) an optimal value of the monetary aggregate to optimize one or more parameters of the knowledge processing system, and (C) one or more monetary supply actions;
(c) a plurality of input devices for receiving a set of inputs from human users of the system and a plurality of transducers for producing a set of outputs, such that (i) the set of inputs includes a first input and a second input, (ii) the set of outputs are humanly perceptible and include a first output, and (iii) the first input comprises an offer by a first user to pay a second user an offer price, in the virtual currency, if the second user pays attention to a first knowledge object.

2. A method comprising, in combination:
(a) one or more memory devices storing data in data structures;
(b) one or more computers applying computer reasoning to calculate (i) a monetary aggregate of a virtual currency in a knowledge processing system, and (ii) one or more monetary supply actions;
(c) a plurality of input devices receiving a set of inputs from human users;
(d) a plurality of transducers producing a set of outputs; and
(e) an encoder encoding data for transmission from an input device, out of the plurality of input devices, to a processor, out of one or more processors;
wherein (i) the set of inputs includes a first input and a second input, (ii) the set of outputs are humanly perceptible and include a first output, (iii) the first input comprises an offer by a first user to pay a second user an offer price, in the virtual currency, if the second user pays attention to a first knowledge object, (iv) the first output comprises a communication of the offer to at least a second user, and (v) the second input comprises an instruction by a second user to download, stream, display visibly or play audibly, the first knowledge object.

3. The method of claim 2, wherein:
(a) the set of inputs that are received includes a communication indicative of a reviewer's review of a knowledge object; and
(b) the set of outputs that are produced comprises a communication to the reviewer confirming payment for the review, which payment is to the reviewer and in the virtual currency.

4. The method of claim 3, wherein the set of outputs includes a communication that specifies a certain monetary aggregate of virtual currency in the system, and that expresses the certain monetary aggregate in units other than units of the virtual currency.

5. The method of claim 2, wherein:
(a) the set of inputs that are received includes a tagging of a knowledge object by a certain user; and
(b) the set of outputs that are produced includes a communication to the certain user confirming payment for the tagging, which payment is to the certain user and is in the virtual currency.

6. The method of claim 1, wherein:
(a) the set of inputs that are received includes inputs by a plurality of users indicating disapproval of a disapproved item, the disapproved item comprising an action or actions by a specific user or a knowledge object inputted by the specific user; and
(c) the set of outputs that are produced comprise a communication to the specific user regarding a penalty, which penalty is against the specific user, is in the virtual currency, and is at least in part for the disapproved item.

7. A method comprising, in combination:
(a) one or more memory devices storing data in data structures;
(b) one or more computers applying computer reasoning (i) to determine an expertise ranking of a particular user of a knowledge processing system; and (ii) to calculate (A) a monetary aggregate of a virtual currency in the knowledge processing system, and (B) one or more monetary supply actions;
(c) a plurality of input devices receiving a set of inputs from human users; and
(d) a plurality of transducers producing a set of outputs;
wherein (i) the set of inputs that are received include a first input and a second input and the set of outputs that are produced include a first output, (ii) the first input comprises an offer by a first user to pay an offer price, in the virtual currency, for a first knowledge object, and the first output comprises a communication of the first offer to other users of the system, and (iii) the second input comprises an input of a first knowledge item by a second user of the system, in response to the first offer.

8. The method of claim 7, wherein the set of inputs that are received includes a review by the first user, which review either (A) reviews the first knowledge object inputted by the second user, (B) reviews how responsive the first knowledge object is to the first offer, or (C) indicates what portion, if any, of the first price should be paid for the first knowledge object.

9. The method of claim 8, wherein the set of outputs that are produced includes a communication to the second user indicating payment, which payment is in the virtual currency, is for the first knowledge object, and is in an amount less than the offer price.

10. The method of claim 7, wherein the method further comprises the one or more processors calculating an optimal value of the monetary aggregate to optimize one or more parameters of the knowledge processing system.

11. The method of claim 7, wherein:
(a) the set of inputs that are received includes a communication indicative of a particular offer by the second user to provide the requested knowledge object for a second price, which second price is higher than the first price; and
(b) the set of outputs that are produced comprises a communication of the particular offer to at least the first user.

12. The method of claim 11, wherein the set of outputs that are produced includes a communication of an expertise ranking of the second user.

13. The method of claim 11, wherein the set of inputs that are received includes an instruction by the first user to download, stream, display visibly or play audibly, preview content, the preview content comprising a part but not all of a knowledge object that the second user has inputted or specified.

14. A method comprising, in combination:
(a) one or more memory devices storing data in data structures;
(b) a plurality of input devices receiving a set of inputs from human users; and
(c) a plurality of transducers producing a set of outputs, each respective output, out of the set of outputs, being humanly perceptible and produced by at least one of the transducers;
wherein
(i) the set of inputs that are received includes a first input and a second input, and the set of outputs that are produced includes a first output,
(ii) the first input comprises a request by a first user of the system for a requested knowledge object, and the first output comprises a communication of the request to other users of the system,
(iii) the second input comprises an input of the requested knowledge item by a second user of the system, and
(iv) the method further comprises one or more processors applying computer reasoning
(A) to determine hits on the requested knowledge item,
(B) to determine an amount of a certain payment to be made in the virtual currency, which amount depends at least in part on the hits,
(C) to identify a set of users, each of whom have rights in the certain payment, which rights are either held by the second user or have been transferred directly or indirectly from the second user, and
(D) to determine allocation of the certain payment among the set of owners, based at least in part on these rights.

15. The method of claim 14, wherein the method further comprises the one or more processors applying computer reasoning to calculate (i) an existing or prior monetary aggregate of a virtual currency in the knowledge processing system, and (ii) one or more monetary supply actions.

16. The method of claim 15, wherein the monetary supply actions comprise paying the virtual currency for tagging or reviewing knowledge objects.

17. The method of claim 15, wherein the monetary supply actions comprise paying an identical amount of the virtual currency to each respective user of the system.

18. The method of claim 15, wherein the method further comprises the one or more processors calculating an optimal value of the monetary aggregate to optimize one or more parameters of the knowledge processing system.

19. The method of claim 14, wherein units of the virtual currency expire within a certain time period after being created.

20. The method of claim 14, wherein the one or more processors apply computer reasoning:
(a) to determine hits on a second knowledge object, which second knowledge object either (i) includes content copied from the requested knowledge object, or (ii) is a revision of the requested knowledge object; and
(b) to calculate an amount of a payment in the virtual currency, which amount depends at least in part on the hits.
